(19) United States
(12) Patent Application Publication
(10) Pub. No.: US 2025/0316154 A1
(43) Pub. Date: Oct. 9, 2025

(54) METHOD FOR DETECTING A SABOTAGE MAGNETIC FIELD AND A CLOSING/OPENING SENSOR FOR PERFORMING THE METHOD (VARIANTS)

(71) Applicant: AJAX SYSTEMS CYPRUS HOLDINGS LTD, Nicosia (CY)

(72) Inventor: Ihor DITSKYI, Kharkiv (UA)

(21) Appl. No.: 19/174,303

(22) Filed: Apr. 9, 2025

(30) Foreign Application Priority Data
Apr. 9, 2024 (UA) A 2024 01822

(51) Int. Cl. G08B 13/24; G08B 29/20

(52) U.S. Cl. CPC G08B 13/2491; G08B 29/20

(57) ABSTRACT

Provided are reliable methods for detecting a sabotage magnetic field and opening/closing sensors for performing the methods, thereby ensuring high sensitivity to various variants of creation of the sabotage magnetic field and ensuring a continuous control of presence or absence of the sabotage field due to continuous measurement of the magnetic field even upon change of a state of doors or windows regardless of whether they are closed or open, whether an object is under protection or not, while at the same time minimizing a sensitivity to interferences that arise within a network during operation of certain devices and, thus, facilitates essential reduction of false positive activations, as well as provides a low power consumption.

### CROSS-REFERENCE TO RELATED APPLICATION

This application claims priority to Ukrainian Application No. a 2024 01822, filed Apr. 9, 2024, which is hereby incorporated by reference in its entirety.

### FIELD OF THE INVENTION

The claimed group of inventions belongs to a field of security technologies and relates to methods for detecting an influence of a third-party sabotage magnet onto a door or window opening/closing contact sensor and sensors, where these methods are implemented, in order to avoid a malicious intrusion.

### BACKGROUND

A malicious intrusion into a house, a flat, an office through doors or windows is a serious problem that may result in property losses and more. Intruders may utilize various intrusion methods, including opening the doors or windows, snapping locks or breaking glass.

Currently, the most effective way to avoid malicious intrusions is to provide a combination of mechanical (robust doors and locks, latches, grids) and electronic (motion sensors or doors and windows opening sensors) safety measures. Said sensors register a presence or absence of a magnetic field, while a source of the magnetic field is usually a permanent magnet that is fixed on a movable part of the doors or window in most cases. These sensors are active only during a period, when an object is under protection. This results in risks that the intruder may generate a sabotage magnetic field, when the sensor is not activated, which will lead to a change of a resultant magnetic field within a sensitivity area of a sensitive element that is a reed switch in most cases and, thus, it will block the sensor operation in a closed mode regardless of whether the doors or the window are/is closed or open.

In order to detect the sabotage magnetic field in the door or window closing/opening sensor, various technologies and systems are used. One of the most widespread methods is to use a difference between magnetic fields that arises upon opening of the doors or the window. The sensors detect changes in the magnetic field indicative of opening or closing.

Systems that utilize this approach may detect an intrusion to the magnetic field, if the intruder tries to use external magnetic fields to impair the sensor operation.

Some modern systems utilize complex approaches, including use of magnetic, radio frequency and other types of sensors. It allows to increase a reliability of the sabotage detection by ensuring the system operation even in case of use of special devices for hindering the operation of individual types of sensors.

Furthermore, advancement of artificial intelligence and machine learning technologies opens new possibilities for the sabotage detection. The systems may utilize analysis of large data volumes in order to detect differences in the usual operation modes of the sensors that may be indicative of intrusion attempts.

The safety is also enhanced by development of special algorithms directed at detection of shortcomings in the operation of the sensors that may be caused by the sabotage. This allows the system to automatically respond to potential threats and to inform corresponding security services about them.

Also, an important part of the prior art is protection against direct intrusion to the sensors. This may include use of methods for protecting communications between the sensors and a central control system.

Methods exist for detecting a sabotage magnetic field that cover various methods and approaches, and the applicant has selected several technical solutions among them, which are the closest to the proposed invention in terms of a set of essential features.

Application TW201719582A dated Jun. 1, 2017, discloses a method for detecting a door and a window state, the method comprises steps of providing a signal generation unit and generating a position signal by means of the signal generation unit; providing a signal sensing module comprising a three-axis accelerator, a three-axis magnetometer and a microcontroller, wherein the signal generation unit is arranged on a side of the door and window, and the signal sensing module is arranged opposite to the signal generation unit; from one side, when the door and the window are actuated, the microcontroller generates a position signal that is generated by the signal generation unit, the three-axis accelerator, and a sensing signal that is generated by the three-axis magnetometer, in order to detect the door and window position followed by security enhancement. A drawback of this method lies in use of the accelerometer for registering the door or window movement, as well as in a limited application to doors and windows that are only under protection or in a rest state. An alarm signal is generated according to results of operation of the accelerometer and the magnetometer that requires additional control, since it bears a number of vulnerabilities that affect the operation reliability.

Also, a patent EP3211613B1 dated Jun. 6, 2018, teaches a method for detecting a door or a window state, the method comprises steps of mounting an accelerometer in a first part of a window frame or a door frame or thereon, mounting a magnetometer in or on the first part of the window unit or the door unit, the accelerometer measures acceleration or vibration relative to a second part of the window unit or the door unit and transmits the measured acceleration or vibration to a microcontroller unit; the magnetometer measures a magnetic field relative to a sensor magnet that is mounted on or embedded into the second part of the window unit or the door unit, and transmits the measured magnetic field to the microcontroller unit; and the microcontroller uses the measured acceleration or vibration and the measured magnetic field to determine a security level. A drawback of this solution is a presence of the accelerometer that also must be calibrated to ensure correct detection of the door state, thereby complicating the usage. Also, a drawback is that additional adjustments for the doors and the windows are required, thereby resulting in a reduction of usage convenience, reduction of reliability and cost increase.

Patent CN109215271B dated Feb. 26, 2021, is taken as the closest analog of the invention. The patent teaches a method for detecting a malicious intrusion behavior, the method comprises steps of continuous collecting a three-axis acceleration and a magnetic field strength of doors within a plurality of points of time; calculating a plurality of absolute values of an acceleration change between consecutive pluralities of points of time within a given time period; calculating absolute values of the three-magnetic field strength change between four consecutive points of time; determining an intruder presence, the intruder uses a magnet for intrusion to the door magnetic field, and sending an alarm signal, if the absolute values of the magnetic field strength change are greater than a magnetic field strength threshold; determining an invasive intrusion behavior and sending an alarm signal, if a peak value of the absolute value of the acceleration change exceeds a three-fold threshold of normal acceleration oscillations, while a time interval between peak values of two adjacent absolute values of the acceleration change exceeds a time threshold; determining a presence of an invasive intrusion behavior and sending an alarm signal, if the peak value is absent, while a maximum absolute value of the acceleration change exceeds the three-fold threshold of normal acceleration oscillations.

A drawback of this solution lies in a limited use only for the doors that are under protection or in a rest state, i.e., when the doors are closed. Also, a drawback is a simple approach that includes a comparison of the absolute values of the magnetic field to the threshold that bears a number of vulnerabilities that affect the operation reliability.

### SUMMARY OF THE INVENTION

Embodiments of the subject invention provide reliable methods for detecting a sabotage magnetic field, compact as well as simple to manufacture and easy to mount sensors for performing said methods that allow to achieve a technical effect that lies in ensuring a high sensitivity to various variants of creation of the sabotage magnetic field and continuous control of presence or absence of the sabotage field due to continuous measurement of the magnetic field even after a change of a state of doors or windows regardless of whether they are closed or open, whether an object is under protection or not, while at the same time minimizing sensitivity to interferences that arise within a network during operation of certain devices and, thus, essentially reducing false positive activations, as well as providing a low power consumption.

In a first aspect of the invention, a method for detecting a sabotage magnetic field, the method comprises steps as follows.

In a constant closed state of a door or a window, calibrating that comprises measuring, by means of a magnetometer that is mounted in an opening/closing sensor that comprises at least one reed switch and a standard magnet, a magnetic field induction of the standard magnet along three orthogonal axes by conducting at least two measurements and determining an arithmetic mean value of the induction along each of the axes that are recorded as reference values. The constant closed state is a closed position of the door or the window, when the magnetic field is present and the reed switch is closed, i.e., the magnetic field is not changed. In order to enhance the operation, the inventor has conducted tests regarding adjustment of the sensor, namely, a preliminarily calibration of the sensor.

After the sensor is mounted and prior to its further usage, the magnetic field induction of the standard magnet of the sensor along three orthogonal axes is measured. The tests have demonstrated that one measurement is not sufficient for reliable operation, since a risk of a false activation of the sensor is increased. For this particular purpose, at least two alignments of the magnetic field induction of the standard magnet along three orthogonal axes are performed and an arithmetic mean value of the induction along each of the axes is determined, and then, these values are recorded in an internal memory of the sensor and considered as reference, i.e., acceptable values. This configuration allows to ensure the operation reliability of the sensor with consideration of a possible movement of the doors or windows in the closed state, e.g., due to air currents, and a possible noise of the sensor itself.

A noise threshold of the magnetometer that equals at least a two-fold level of a real noise of the magnetometer is set and recorded in a memory. It is known in the art that any device or appliance, including the magnetometer, has its own noises that may affect measurement accuracy. The noises may be caused by various factors such as technological manufacturing features, electromagnetic radiations, thermal oscillations, etc. In order to ensure a more reliable operation, a noise threshold is set. It is performed to filter out arbitrary noises and to ensure more stable and accurate measurements. In order to enhance the operation, the inventor has conducted tests regarding the set noise threshold. The tests have demonstrated that the set noise threshold of the magnetometer should be equal to a level that is at least two times greater than the real noise level of the sensor, since it allows to ensure the reliable operation by ignoring the noises that do not exceed the set threshold.

The current values of the magnetic field induction along each of the three axes are periodically measured on a constant basis. In the present context, the constant measurement means that the process of measuring the current values of the magnetic field induction along each of the three axes is performed periodically, but without consideration of the fact whether the object is in the “security” status or not. It means that regardless of circumstances, the measurements are performed systematically in order to ensure the constant control of the magnetic field. This approach allows to detect any changes in the magnetic field induction timely regardless of whether they are associated with the security status of the object or not. This is important to ensure safety, to detect possible problems or violations, as well as to monitor an environment or the object that may be subjected to magnetic field changes due to various reasons.

During said measurement, increment modules between the current and the previous values of the magnetic field induction along each of the three axes are determined and, at the same time, arithmetic mean values of the measured current values of the magnetic field inductions are determined.

The increment modules are determined in order to detect the changes of the magnetic field inductions between the current and the previous values along each of the three axes. This allows to detect movements or changes in positions of the objects or environment that may affect the magnetic field. Determination of the increment modules allows to detect even minor changes in the magnetic field induction that may be indicative of various events or movements, e.g., opening of the door or the window, movement, etc. This is important for safety monitoring systems, access control or detection of any unexpected events. It is known in the art that an accelerometer is used to register the door or window movement. However, the accelerometer bears its own drawbacks, in particular, it requires to consider a noise threshold, thereby reducing operation range and sensitivity of the sensor. These limitations may complicate the detection of some movements or changes, in particular, when measuring weak signals.

The obtained increment modules are compared to the set noise threshold and, if the increment modules are greater than the set noise threshold level, a quit from the constant state will be registered, while if the increment modules are reduced to the set noise threshold level and lower, the constant open state or a return to the constant closed state will be registered. The quit from the constant state is the movement of the door or the window, i.e., closing/opening, when the magnetic field changes. The constant open state is the open position of the door or the window, when the magnetic field is absent and the reed switch is broken. As described above, it is known that in order to detect the door or window movement, the accelerometer is used, as well as the drawbacks thereof are mentioned. When comparing the increment modules to the set noise threshold, it may be determined whether there were any changes of the values that are indicative of the possible door or window movement. If the increment modules are greater than the set noise threshold, then it will be indicative of the door or window movement, e.g., opening, and the quit from the constant state will be registered, and, on the contrary, if the increment modules are reduced to the set noise threshold and lower, it will be indicative of the constant open state or of the return of the door or the window back to the constant closed state. This approach ensures reliable operation under quick changes of the magnetic field that arise during normal closing/opening of the door or the window.

At the same time, after returning back to the constant closed state, the current values of the magnetic field induction along all the three axes are one-time compared to the reference values, and then the arithmetic mean values of the current values of the magnetic field induction are compared to the reference values.

If the current values of the magnetic field induction are greater than the reference values by a value that is greater than the set noise threshold at least along one axis, or if the arithmetic mean value of the current values of the magnetic field induction is greater than the reference values by a value that is greater than the set noise threshold, a sabotage magnetic field signal will be generated. In order to enhance the operation, the inventor has conducted tests regarding detection of vulnerabilities and making a decision about presence or absence of the sabotage magnetic field. The tests have demonstrated that a number of measures should be taken in order to increase the operation reliability. One of these measures is to determine the current values of the magnetic field induction and to compare them to the reference values in order to detect sabotage. The tests have demonstrated that if a sabotage magnet is approached very slowly so as the field is not changed greater than the set noise threshold level at one measurement cycle, then the algorithm eventually will not proceed to the comparison of the current values of the magnetic field induction to the reference values. For this particular purpose, in the constant closed state, when the door or the window remains closed, only the arithmetic means values of the current magnetic field induction values will be compared to the reference values. It allows to determine whether the changes that may be indicative of the presence of the sabotage field occurred. Upon quit from the constant state, i.e., upon opening of the door or the window, the magnetic field will be changed significantly or disappear completely. When the door or the window returns back to the constant closed state, the determination of the arithmetic mean values of the current magnetic field induction values will take some time. For this particular purpose, the current values of the magnetic field induction are compared to the reference values, since this configuration affects the speed of detection and making the decision about the sabotage magnetic field, when the door or the window has returned back to the constant closed state, i.e., has just closed. Then, the system proceeds to the comparison of the arithmetic mean values of the current values to the reference values in order to ensure reliability and to avoid any false activation of the sensor. The tests have demonstrated that this approach allows to increase the efficiency, to reduce a probability of false activations and to ensure the precision of the sabotage magnetic field detection.

According to one of exemplary embodiments of the invention, the constant measurement of the current values of the magnetic field induction along each of the three axes is performed with a periodicity of at least 300 ms, while their arithmetic mean values are determined during the measurement time of between 1 and 5 sec.

According to another exemplary embodiment, the at least one reed switch is subjected to constant control, where if the arithmetic mean values of the current values are within the set noise threshold and, at the same time, there is no magnetic field in a point of location of the reed switch and the reed switch is closed, the sabotage magnetic field signal will be generated.

According to one of exemplary embodiments of the invention, the at least one reed switch is subjected to constant control, where if the arithmetic mean values of the current values are within the set noise threshold and, at the same time, there is a magnetic field in a point of location of the reed switch and the reed switch is broken, the sabotage magnetic field signal will be generated.

According to another exemplary embodiment, upon quit from the constant state, a number of changes of increment signs along each of the axes is further considered, while if 4-7 changes of the increment signs during 4-6 sec are detected, the sabotage magnetic field signal will be generated.

In order to implement a variant of the above-mentioned method of the group of inventions, a closing/opening sensor is developed. The sensor consists of two parts that are configured to be fixed on a movable or immovable part of the door or window, the first part comprises the standard magnet, while the second part comprises the three-axis magnetometer that is coupled to the microcontroller, at least one reed switch, and a power source. The microcontroller is configured to:
record the reference values and the noise threshold,
constant periodical measurement, by means of the magnetometer, the magnetic field induction along three orthogonal axes of the standard magnet in real-time,
determine the increment modules of the magnetic field induction along each of the three axes,
determine the arithmetic mean values of the magnetic field induction,
compare the increment modules, the three-axis magnetic field induction and the arithmetic mean values of the magnetic field induction,
generate the sabotage magnetic field signal.

According to one of exemplary embodiments of the invention, the constant periodical measurement of the magnetic field induction is performed at least every 300 ms.

In a second aspect of the group of inventions, the technical objective is achieved by providing a variant of a method for detecting a sabotage magnetic field, the method comprises steps as follows.

In a constant closed state, calibrating a closing/opening sensor comprising at least two reed switches and a standard magnet, the calibrating comprises measuring, by means of a magnetometer that is mounted in the sensor, a magnetic field induction of the standard magnet along three orthogonal axes by conducting at least two measurements and determining an arithmetic mean value of the induction along each of the axes that are recorded as reference values, and registering a state of the at least two reed switches. The state of the reed switches is registered by direct reading of states of pins to which the reed switches are connected. If the reed switches are closed, a logical null will be at an input, while if they are not closed, a logical one will be at the input.

A noise threshold of the magnetometer that equals to at least two-fold level of a real noise of the magnetometer is set.

Current values of the magnetic field induction along each of the three axes are periodically measured on a constant basis, and it comprises determining increment modules between the current and previous values of the magnetic field induction along each of the three axes.

At the same time, arithmetic mean values of the measured current values of the magnetic field induction are determined.

The increment modules are compared to a set noise threshold and, if the increment modules are greater than the set noise threshold level, a quit from the constant state will be registered, while if the increment modules are reduced to the set noise threshold level and lower, a constant open state or a return to the constant closed state will be registered.

At the same time, after the return to the constant closed state, the current values of the magnetic field induction along all the three axes are one-time compared to the reference values, and then the arithmetic mean values of the current values of the magnetic field induction are compared to the reference values, as well as the current state of the reed switches are compared to the state registered during the calibration process.

In order to increase the operation reliability of the sensor, the inventor has conducted tests regarding settings of the sensor mounted on metal doors or windows. The tests have demonstrated a dissipation (closure) of the magnetic fields across a metal surface of the metal doors or windows, i.e., the measured field is reduced. It is possible that the field remains almost unchanged, but the sabotage is detected only after opening of the door or the window. This is allowable as per the standard, but it may be ambiguous for a user.

During the tests, it has been noted that upon reduction of the fields only one reed switch is closed, while when the sabotage magnet from another side is approached, another reed switch is closed. For this particular purpose, the state of both the reed switches is registered and the current state of the reed switches is compared to the state registered during the calibration process.

In the constant closed state, when the current values of the magnetic field induction are greater than the reference values by a value that is greater than the set noise threshold along at least one axis or when the arithmetic mean value of the current values of the magnetic field induction is greater than the reference values by a value that is greater than the set noise threshold or when the arithmetic mean values change by a value that is greater than the noise value, while at the same time do not exceed the reference values and the current states of the reed switches differ from the registered states, a sabotage magnetic field signal will be generated.

In order to implement this variant of the claimed method of the group of inventions, a closing/opening sensor is developed, the sensor consists of two parts that are configured to be fixed on a movable part and an immovable part of a door or a window. The first part comprises a standard magnet, while the second part comprises a three-axis magnetometer that is coupled to a microcontroller, at least two reed switches and a power source, and the microcontroller is configured to:
record the reference values, states of the at least two reed switches and the noise threshold,
constant periodical measurement, by means of the magnetometer, the magnetic field induction along three orthogonal axes of the standard magnet in real-time,
determine the increment modules of the magnetic field induction along each of the three axes,
determine the arithmetic mean values of the magnetic field induction,
compare the increment modules, the three-axis magnetic field induction and the arithmetic mean values of the magnetic field induction,
generate the sabotage magnetic field signal.

### BRIEF DESCRIPTION OF THE DRAWINGS

In order to provide more complete understanding of the claimed invention and advantages thereof, the following description explains possible exemplary embodiments thereof with a reference to figures of the appended drawings, wherein identical designations denote identical parts, and which illustrate the following:

FIG. 1 illustrates a block diagram of the closing/opening sensor for implementation of the method according to the first variant;

FIGS. 2A and 2B illustrate a block diagram of the first variant of the method for detecting a sabotage magnetic field;

FIGS. 3A and 3B illustrate a block diagram of the first exemplary variant of the method for detecting a sabotage magnetic field under constant control of at least one reed switch;

FIGS. 4A and 4B illustrate a block diagram of the first exemplary variant of the method for detecting a sabotage magnetic field with consideration of a number of changes of increment signs;

FIGS. 5A and 5B illustrate a block diagram of the second variant of the method for detecting a sabotage magnetic field;

FIG. 6 illustrates a block diagram of the closing/opening sensor for implementation of the second variant of the method.

### MAIN DESIGNATIONS

1. magnetometer;
2. microcontroller;
3. reed switch;
4. reed switch (left);
5. reed switch (right);
6. power source.

The drawings that explain the claimed inventions and the disclosed specific exemplary embodiments do not limit the claimed scope of rights in any way, rather they only explain the essence of the inventions.

### IMPLEMENTATION OF THE INVENTION

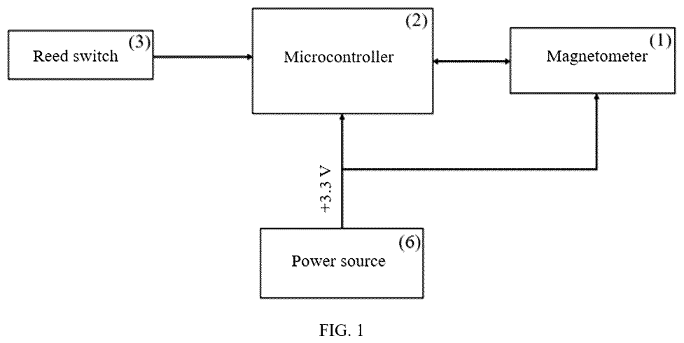

In order to implement the method for detecting a sabotage magnetic field according to a first variant of the claimed invention, a closing/opening sensor illustrated in FIG. 1 is used, the sensor consists of two parts that are configured to be fixed on a movable part and an immovable part of a door or a window, the first part comprises a standard magnet, while the second part comprises a three-axis magnetometer (1) that is coupled to a microcontroller (2), a reed switch (3) and a power source (6).

The microcontroller (2) performs collection of data, processing, analysis, and decision making.

The data collection is a constant periodic measurement, by means of the magnetometer (1), of current values of a magnetic field induction along three orthogonal axes of the standard magnet in real-time. The current values are signed double-byte values being m_x_new, m_y_new, m_z_new, while the magnetic field values obtained during previous measurement are signed double-byte values being m_x_old, m_y_old, m_z_old.

Processing and analysis represent determination of increment modules of the magnetic field induction along each of the three axes that have values dm_x, dm_y, dm_z, determination of arithmetic mean values of the magnetic field induction, comparison of the increment modules of the three-axis magnetic field induction and the arithmetic mean values of the magnetic field induction.

The step of making a decision represents generating a signal about a presence or absence of a sabotage magnetic field, while the decision is taken according to results of the processing and analysis.

The standard magnet may be a permanent magnet, an electromagnet, or any other type of magnet known in the art that generates a magnetic field. It may have any dimensions, shape, and magnetic field strength.

Various types of magnetometers are known in the art, e.g., magneto-resistive magnetometers, inductive magnetometers, quantum magnetometers, etc. In order to implement the invention, the magnetometer (1) based on three Hall sensors is used, the magnetometer is a three-axis magnetometer and measures the magnetic field induction along three orthogonal axes. The magnetometer (1) is coupled to the microcontroller (2), thereby allowing to control the magnetometer (1) and to set a measurement periodicity.

The microcontroller (2) is a microprocessor that processes information and manages processes.

The sensor may be a conductive sensor that is wired or wirelessly connectable to the power source and an alarm system as well as equipped with a battery and a wireless communication module. In order to ensure stable operation of the sensor and low power consumption, the power source (6) supplies a voltage of 3.3 V to the microcontroller (2) and the magnetometer (1).

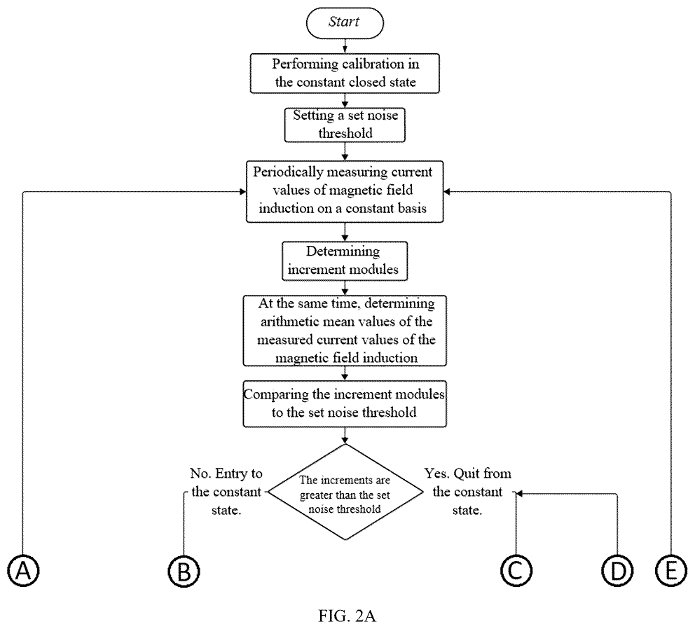

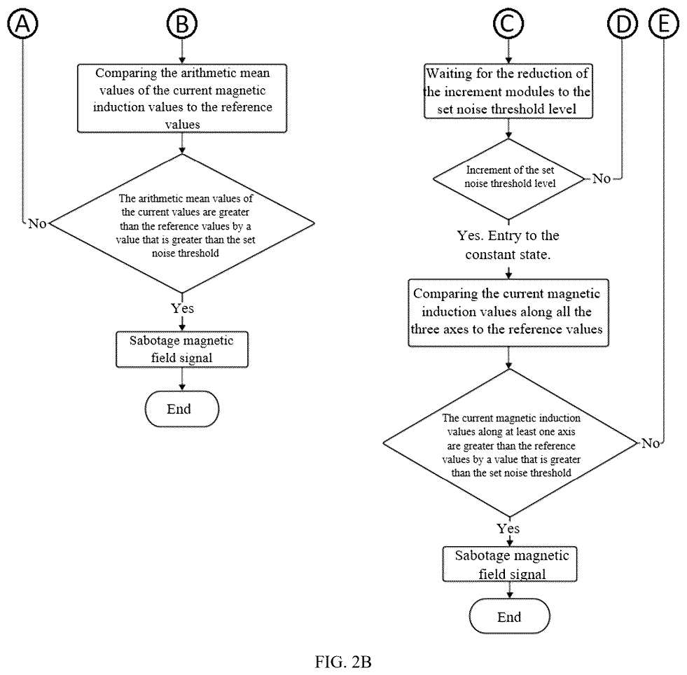

FIGS. 2A and 2B illustrate a block diagram of a preferable exemplary embodiment of the method for detecting a sabotage magnetic field according to the first variant of the claimed invention, the method comprises steps of: calibrating the sensor in a constant closed state of the door or the window; setting a noise threshold of the magnetometer (1); conducting constant periodical measurement of the current values of the magnetic field induction along each of the three axes, while determining increment modules between the current and previous values of the magnetic field induction along each of the three axes with a periodicity of 300 ms; and, at the same time, determining arithmetic mean values of the measured current values of the magnetic field induction that are determined during a measurement time of between 1 and 5 sec; comparing the increment modules to the set noise threshold.

If the increment modules are not greater than the set noise threshold, then an entry to a constant open state will be registered, when the door or the window is in an open position, but they have no movement and the magnetic field does not change, e.g., the door or the window has left open for ventilation of a room. If the increment modules are not greater than the set noise threshold, then an entry to a constant closed state will be registered, when the door or the window is closed. The constant open state and the constant closed state, i.e., door or window positions, are determined not only according to the increments, but also according to the measured current values and by constant control of the reed switch (3). If the current values of the magnetic field induction are lower than the set noise threshold and the reed switch (3) is broken, then the door or the window is open. If the current values of the magnetic field induction are greater than the set noise threshold and the reed switch (3) is closed, then the door or the window is closed.

If the increment modules are not greater than the set noise threshold, then a residence in the constant closed state will be registered, i.e., the door or the window is closed. At the same time, the arithmetic mean values of the current values of the magnetic field induction are compared to the reference values, and if the arithmetic mean values of the current values are greater than the reference values by a value that is greater than the set noise threshold, then the sabotage magnetic field signal will be generated. If the arithmetic mean values of the current values are not greater than the reference values, then the method returns to the step of measuring the current values of the magnetic field induction.

If upon comparison of the increment modules they are greater than the set noise threshold, then a quit from the constant state will be registered, i.e., the movement of the door or the window occurs and the field changes. The increment modules are expected to reduce down to the level of the set noise threshold and the increment modules are determined and compared constantly. If the increments reached the set noise threshold or lower, then the constant open state or a return back to the constant closed state will be registered. After returning to the constant closed state, the current values of the magnetic field induction along all three axes are compared to the reference values. If the current values are greater than the reference values by a value that is greater than the set noise threshold, then the sabotage magnetic field signal will be generated. If the current values are not greater than the reference values, then the method returns to the step of measuring the current values of the magnetic field induction.

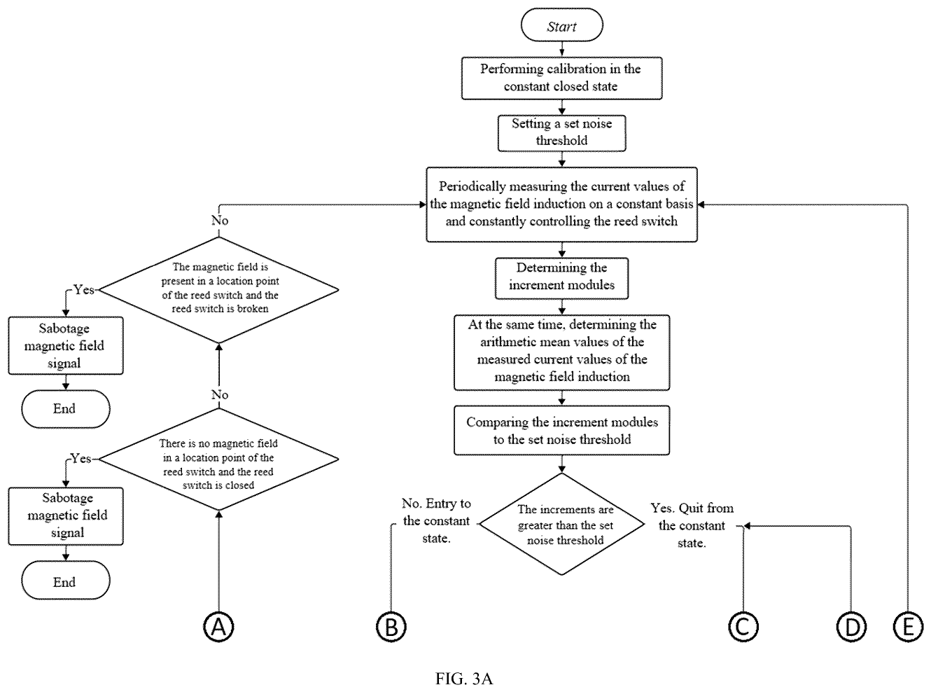

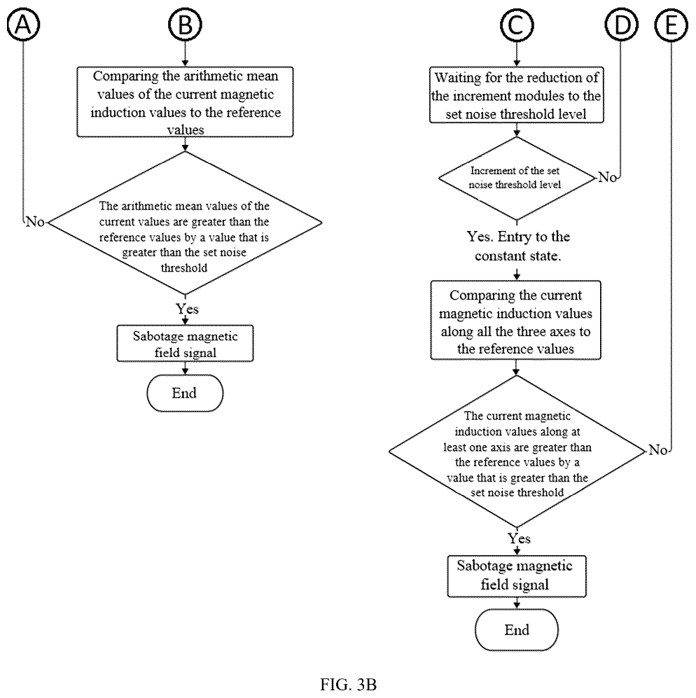

In order to increase the operation reliability of the sensor and to detect the sabotage magnetic field, the reed switch (3) is subjected to continuous control as illustrated in FIGS. 3A and 3B. If the arithmetic mean values of the current values of the magnetic field induction are within the set noise threshold, as well as if there is no magnetic field in a location point of the reed switch (3) and the reed switch (3) is closed, then the sabotage magnetic field signal will be generated. If the arithmetic mean values of the current values of the magnetic field induction are within the set noise threshold, as well as if the magnetic field is present in a location point of the reed switch (3) and the reed switch (3) is broken, then the sabotage magnetic field signal will be generated.

In order to enhance the operation, the inventor has conducted tests regarding detection of vulnerabilities in the sensor operation. The tests have demonstrated that there is a vulnerability that allows to enter the room without registration of the sabotage magnetic field. This vulnerability is associated with operation in two states: quit from the constant state, when the magnetic fields start to change, and a constant state that includes the constant open state and the constant closed state, when there is no change of the magnetic field.

In order to avoid false activations during closing and opening of the door or the window upon registration of the quit from the constant state, the sensor waits until the magnetic field stops to change, i.e., it returns to the constant closed state or the constant open state, and only after that, it decides whether it is a sabotage or simply closing/opening of the door or the window. However, if a sabotage magnet quickly approaches the sensor after the door or the window is closed and it is moved along the sensor axis such that the reed switches are not broken, while the magnetic field changes, then it will become possible to bypass the activation of the sensor. Whilst the sensor waits for the constant state, it is possible to open the door or the window, while continuing to move the sabotage magnet, then to close them and quickly remove the sabotage magnet. The sensor will not generate any sabotage magnetic field signal and will not register the opening of the door or the window.

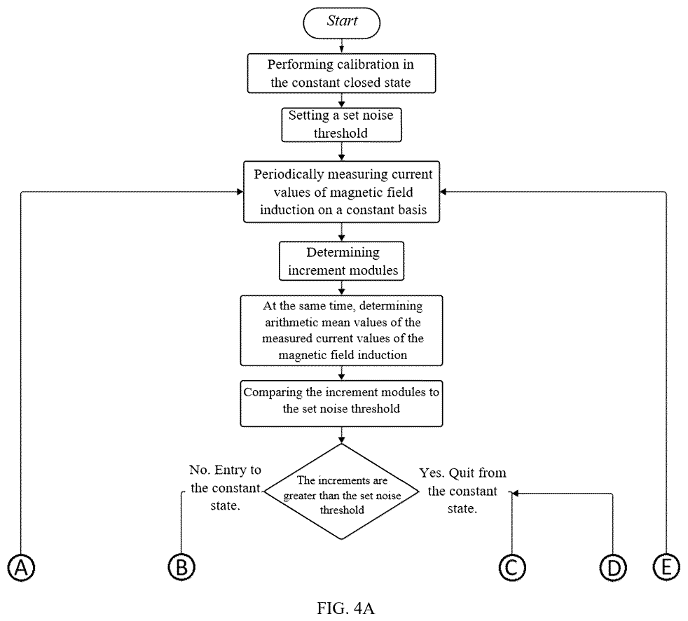

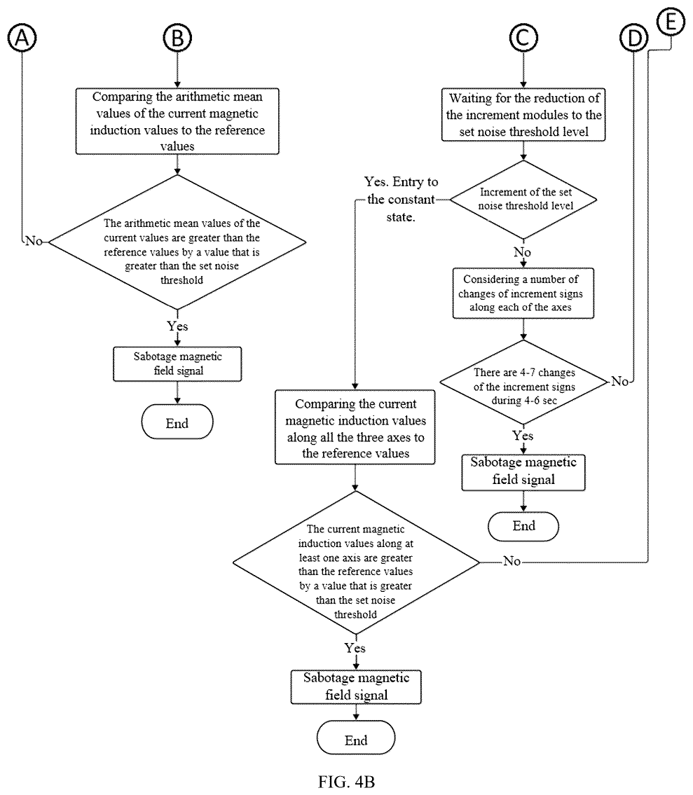

In order to eliminate this vulnerability, an additional algorithm that is illustrated in FIGS. 4A and 4B allows to monitor these field changes and to detect the sabotage. Its operation principle is based on calculation of increment signs of the magnetic fields in each point of time and along each of the axes having values d_xm, d_ym, d_zm, and if the increment sign along at least one of the axes changes for more than 4-7 times during 4-6 secs, the sabotage magnetic field signal will be generated. The control of the changes of the increment signs starts during quit from the constant state. If the number of changes of the increment signs is not greater than 4-7 during 4-6 sec, then a counter of the changes of the increment signs will be reset and will start to count again.

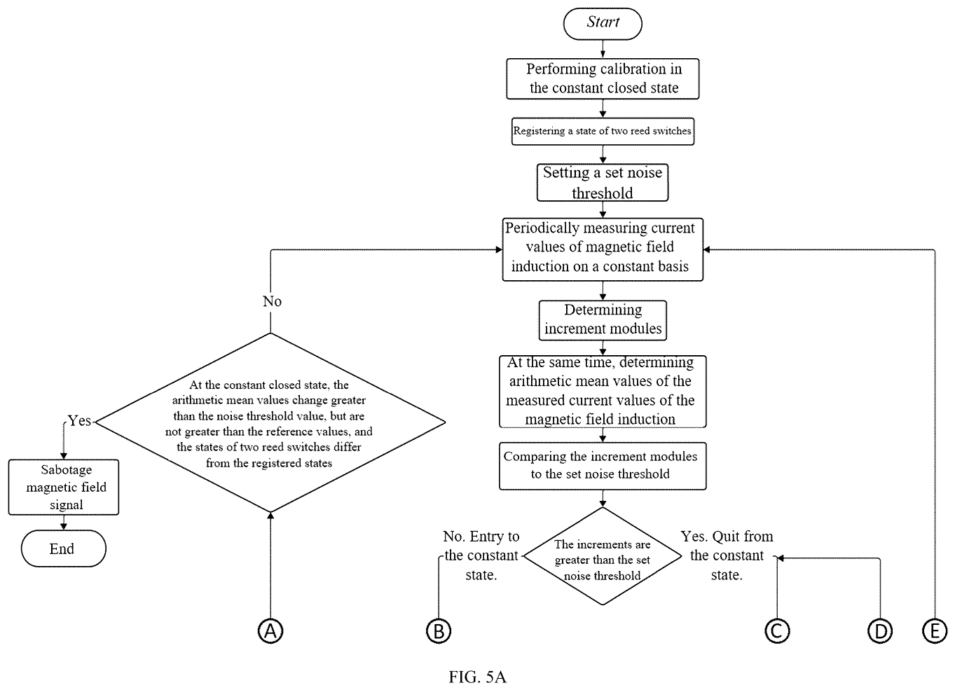

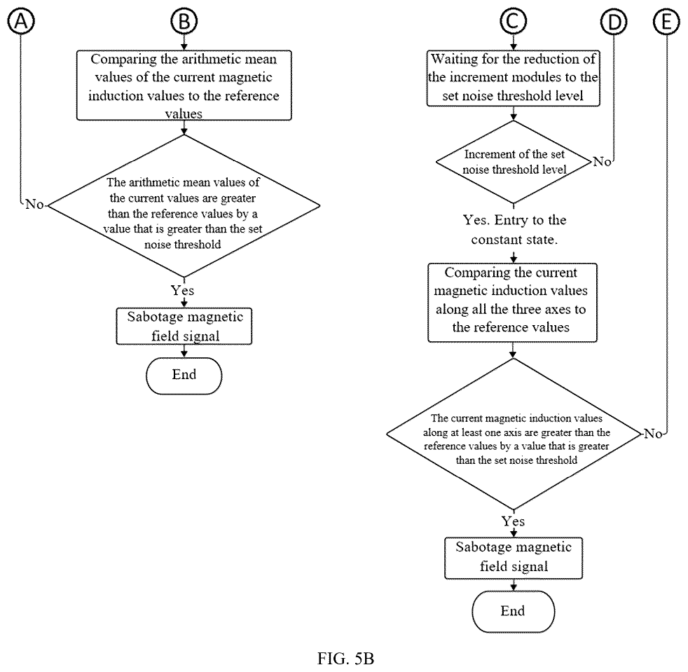

Due to dissipation (closure) of the magnetic fields across a metal surface, e.g., if the sensor is mounted on a metal door or window, reduction of the magnetic field measured by the sensor occurs. It is possible to find a mutual arrangement of the sensor and the standard magnet such that when the sabotage magnet is present, the magnetic field almost will not be changed, while the sabotage will be registered only during opening of the door or the window, since in this case the field from the sabotage magnet will differ markedly from the reference values. On one hand, according to the standard, this situation is acceptable, since the intruder will not manage to enter the room in any way, but in terms of operation, this situation is ambiguous for the user. For this particular purpose, a second variant of the method for detecting a sabotage magnetic field has been developed, and this method is illustrated in FIGS. 5A and 5B.

During tests of the magnetic fields in the described situation, it has been noticed that only one reed switch (right) (5) is closed due to reduction of the magnetic fields on the metal surface, while the sabotage magnet approaches on another side, then the reed switch (left) (4) is closed correspondingly, although the field measured by the magnetometer (1) is within the set noise thresholds. Or, on the contrary, only one reed switch (left) (4) is closed, while when the sabotage magnet approaches from another side, then the reed switch (right) (5) is closed correspondingly.

For this particular purpose, the states of both the reed switches (4, 5) are considered during calibration. If the magnetic field starts to change gradually, when the door or the window is in the constant closed state, namely, the magnetic field starts to change relative to the arithmetic mean values by more than the noise value, while it does not exceed the reference values determined during calibration, and the current states of the reed switches (4, 5) differ from the states registered during calibration, then the sabotage magnetic field signal will be generated.

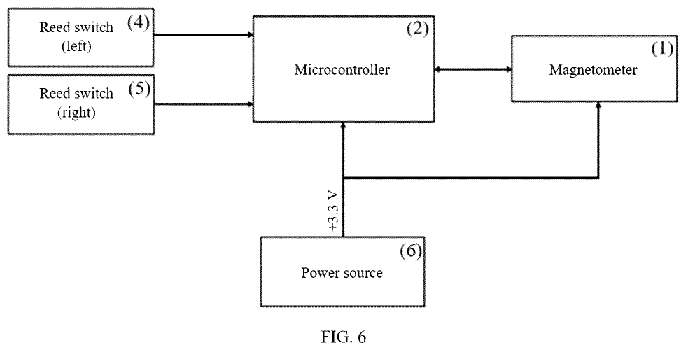

In order to implement the method for detecting a sabotage magnetic field according to a second variant of the claimed invention, a closing/opening sensor illustrated in FIG. 6 is used, the sensor consists of two parts that are configured to be fixed on a movable part and an immovable part of a door or a window, the first part comprises a standard magnet, while the second part comprises a three-axis magnetometer (1) that is coupled to a microcontroller (2), two reed switches (4, 5) and a power source (6).

The sensor comprises two reed switches (4, 5), and one reed switch (4) is mounted on the left, while another reed switch (5) is mounted on the right relative to a sensor housing. This configuration facilitates mounting and ensures additional control.

The claimed group of inventions allows to provide reliable methods for detecting a sabotage magnetic field and opening/closing sensors for performing the claimed methods, thereby ensuring high sensitivity to various variants of creation of the sabotage magnetic field and ensuring a continuous control of presence or absence of the sabotage field due to continuous measurement of the magnetic field even upon change of a state of doors or windows regardless of whether they are closed or open, whether an object is under protection or not, while at the same time minimizing sensitivity to interferences that arise within a network during operation of certain devices and, thus, facilitates essential reduction of false positive activations, as well as provides a low power consumption.

1. A method for detecting a sabotage magnetic field, the method comprising:
in a constant closed state of a door or a window, calibrating a closing/opening sensor comprising at least one reed switch and a standard magnet, the calibrating comprises measuring, by means of a magnetometer that is mounted in the sensor, a magnetic field induction of the standard magnet along three orthogonal axes by conducting at least two measurements and determining an arithmetic mean value of the induction along each of the axes that are recorded as reference values,
setting a noise threshold of the magnetometer that equals at least two-fold level of a real noise of the magnetometer,
periodically measuring current values of the magnetic field induction along each of the three axes on a constant basis,
the periodically measuring comprising determining increment modules between the current and previous values of the magnetic field induction along each of the three axes,
while at the same time measuring arithmetic mean values of the measured current values of the magnetic field induction,
comparing the increment modules to a set noise threshold and, if the increment modules are greater than the set noise threshold level, registering a quit from the constant state, while if the increment modules are reduced to the set noise threshold level and lower, registering a constant open state or a return to the constant closed state,
and, after the return to the constant closed state, one-time comparing the current values of the magnetic field induction along all the three axes to the reference values, and further comparing the arithmetic mean values of the current values of the magnetic field induction to the reference values,
if the current values of the magnetic field induction are greater than the reference values by a value that is greater than the set noise threshold at least along one axis, or if the arithmetic mean value of the current values of the magnetic field induction is greater than the reference values by a value that is greater than the set noise threshold, generating a sabotage magnetic field signal.

2. The method according to claim 1, wherein the constant measurement of the current values of the magnetic field induction along each of the three axes is performed with a periodicity of at least 300 ms, while their arithmetic mean values are determined during measurement time of between 1 and 5 sec.

3. The method according to claim 1, wherein additionally, the at least one reed switch is subjected to constant control, where if the arithmetic mean values of the current values are within the set noise threshold and, at the same time, there is no magnetic field in a point of location of the reed switch and the reed switch is closed, then a sabotage magnetic field signal is generated.

4. The method according to claim 1, wherein additionally, the at least one reed switch is subjected to constant control, where if the arithmetic mean values of the current values are within the set noise threshold and, at the same time, the magnetic field is present in a point of location of the reed switch and the reed switch is broken, then a sabotage magnetic field signal is generated.

5. The method according to claim 1, wherein upon quit from the constant state, a number of changes of increment signs along each of the axes is further considered, while if 4-7 changes of the increment signs during 4-6 sec are detected, then a sabotage magnetic field signal is generated.

6. A closing/opening sensor for implementing the method according to claim 1, the sensor comprising two parts that are configured to be fixed on a movable or immovable part of a door or a window, a first part comprises a standard magnet, while a second part comprises a three-axis magnetometer that is coupled to a microcontroller, at least one reed switch, and a power source, and the microcontroller is configured to:
record reference values and a noise threshold,
constantly periodically measure, by means of the magnetometer, a magnetic field induction along three orthogonal axes of the standard magnet in real-time,
determine increment modules of the magnetic field induction along each of the three axes,
determine arithmetic mean values of the magnetic field induction,
compare the increment modules, a three-axis magnetic field induction, and arithmetic mean values of the magnetic field induction, and
generate a sabotage magnetic field signal.

7. The sensor according to claim 6, wherein the constant periodical measurement of the magnetic field induction is performed at least every 300 ms.

8. A method for detecting a sabotage magnetic field, the method comprising:
in a constant closed state of a door or a window, calibrating a closing/opening sensor comprising at least two reed switches and a standard magnet, the calibrating comprises measuring, by means of a magnetometer that is mounted in the sensor, a magnetic field induction of the standard magnet along three orthogonal axes by conducting at least two measurements and determining an arithmetic mean value of the induction along each of the axes that are recorded as reference values,
registering a state of the reed switches,
setting a noise threshold of the magnetometer that equals at least two-fold level of a real noise of the magnetometer,
periodically measuring current values of the magnetic field induction along each of the three axes on a constant basis,
the periodically measuring comprising determining increment modules between the current and previous values of the magnetic field induction along each of the three axes,
while at the same time measuring arithmetic mean values of the measured current values of the magnetic field induction,
comparing the increment modules to a set noise threshold and, if the increment modules are greater than the set noise threshold level, then registering a quit from the constant state, while if the increment modules are reduced to the set noise threshold level and lower, then registering a constant open state or a return to the constant closed state,
and, after the return to the constant closed state, one-time comparing the current values of the magnetic field induction along all the three axes to the reference values, and then comparing the arithmetic mean values of the current values of the magnetic field induction to the reference values, as well as comparing the current state of the reed switches to the state registered during the calibration process,
when the current values of the magnetic field induction are greater than the reference values by a value that is greater than the set noise threshold along at least one axis or when the arithmetic mean value of the current values of the magnetic field induction is greater than the reference values by a value that is greater than the set noise threshold or when the arithmetic mean values change by a value that is greater than the set noise threshold, while at the same time do not exceed the reference values and the current states of the reed switches differ from the registered states, then generating a sabotage magnetic field signal.

9. A closing/opening sensor for implementing the method according to claim 8, the sensor comprising two parts that are configured to be fixed on a movable or immovable part of the door or window, a first part comprises a standard magnet, while a second part comprises a three-axis magnetometer that is coupled to a microcontroller, at least two reed switches, and a power source, and the microcontroller is configured to:
record reference values, states of the reed switches and a noise threshold,
constantly periodically measure, by means of the magnetometer, a magnetic field induction along three orthogonal axes of the standard magnet in real-time,
determine increment modules of the magnetic field induction along each of the three axes,
determine arithmetic mean values of the magnetic field induction,
compare the increment modules, a three-axis magnetic field induction, and arithmetic mean values of the magnetic field induction, and
generate a sabotage magnetic field signal.
